(19) United States
(12) Patent Application Publication
(10) Pub. No.: US 2024/0249287 A1
(43) Pub. Date: Jul. 25, 2024

(54) SYSTEM AND METHOD FOR IMPROVING TRANSACTION SECURITY BY DETECTING AND PREVENTING UNKNOWN RECURRING TRANSACTIONS

(71) Applicant: Capital One Services, LLC, McLean, VA (US)

(72) Inventors: Jeffrey Carlyle WIEKER, Falls Church, VA (US); Lawrence DOUGLAS, McLean, VA (US); Marisa LEE, Washington, DC (US)

(73) Assignee: Capital One Services, LLC, McLean, VA (US)

(21) Appl. No.: 18/099,773

(22) Filed: Jan. 20, 2023

(51) Int. Cl. G06Q 20/40; G06N 20/00

(52) U.S. Cl. CPC G06Q 20/4016; G06N 20/00

(57) ABSTRACT

A system and method for detecting a recurring charge that is unknown to the customer and/or the result of fraud or deceit is disclosed. A customer complaint initiates an analysis of a particular transaction. In response to the complaint, information relating to the transaction is extracted and used to identify additional information from a variety of different sources. Such information may include information relating to the customer, information relating to the merchant, as well as information relating to past transactions or related transactions. This information is provided to a machine learning algorithm, both for training purposes and for analysis purposes. The machine learning algorithm analyzes a transaction in order to determine the likelihood that the transaction is a recurring transaction, as well as the likelihood that it is a result of a bad actor, fraud or deceit.

### TECHNICAL FIELD

Embodiments of the present disclosure are related to merchant transactions, and specifically to identifying and preventing suspicious recurring charges.

### BACKGROUND

Electronic tracking systems can keep track of purchases, investments, expenses, etc. However, these systems are limited because they are incapable of detecting fraudulent activity from recurring charges. For example, most purchases, investments, and expenses are stand-alone in that the customer authorizes a single payment, and no further payments occur until the customer provides a new authorization for such a payment. However, other charges are recurring. Recurring charges require only a single customer authorization for a charge that repeats on a regular basis. Although most recurring charges are made known to the customer at time of authorization, some recurring charges obscure their recurrent nature so as trick or defraud the customer into authorizing multiple charges without their knowledge. Because current financial accounting systems lack the capabilities to detect these types of transactions, customers may have recurring charges existing on their accounts for long periods of time without their knowledge. This can have a significantly detrimental effect on a customer's financial stability.

### BRIEF DESCRIPTION OF THE DRAWINGS/FIGURES

The accompanying drawings are incorporated herein and form a part of the specification.

FIG. 1 illustrates a block diagram of exemplary recurring charge detection environment according to various embodiments.

FIG. 2 illustrates a block diagram of an exemplary recurring charge detection system according to various embodiments.

FIG. 3 illustrates a flowchart diagram of an exemplary method for training an algorithm to detecting suspicious recurring charges according to various embodiments.

FIG. 4 illustrates a flowchart diagram of an exemplary method for identifying suspicious recurring charges according to various embodiments.

FIG. 5 illustrates an exemplary computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for detecting suspicious recurring charges and preventing them or notifying a customer as to their existence.

Most purchases, investments, expenses are stand-alone in that the customer authorizes a single payment, and no further payments occur until the customer provides a new authorization for such a payment. However, other charges are recurring. Recurring charges require only a single customer authorization for a charge that repeats on a regular basis. However, bad actors seeking to take advantage of customers will occasionally submit recurring charges unbeknownst to the customer, either because the customer was not properly informed, or because the customer was deceived. Such a recurring charge might be charged to the customer several times before the customer discovers the issue and remedies the situation. Because current financial accounting systems lack the capabilities to detect these types of transactions, customers may have recurring charges existing on their accounts for long periods of time without their knowledge. This can have a significantly detrimental effect on a customer's financial stability. Therefore, the present disclosure describes system and method for identifying such recurring charges at their origin, and particularly to identifying recurring charges that are suspicious or associated with bad actors within financial accounting/transaction data.

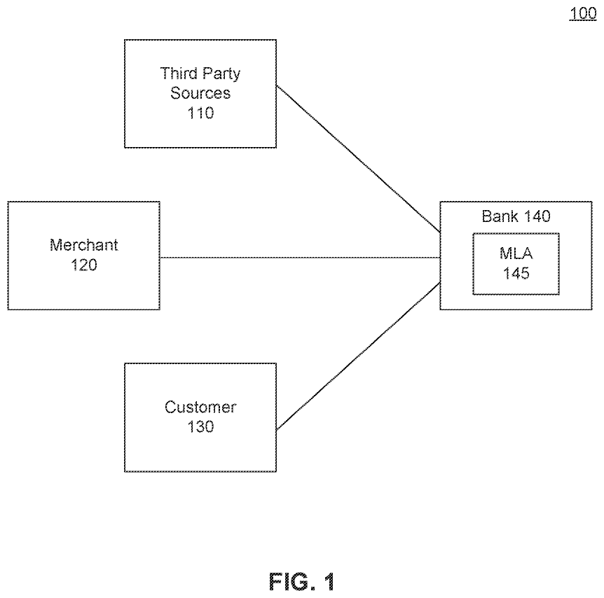

FIG. 1 illustrates a block diagram of exemplary recurring charge detection environment 100 according to various embodiments. As shown in FIG. 1, a bank 140 includes a machine-learning algorithm (“MLA”) 145 for carrying out the recurring charge detection. According to various embodiments, the bank 140 can be any institution capable of processing charges by the customer, such as a credit card company, credit union, or other institution.

The bank entity 140 receives certain information from a customer entity 130 and a merchant entity 120. For example, in an embodiment, the bank 140 receives transaction data from the merchant 120 that includes an amount of the transaction, a date of the transaction, payment information including customer account data, and data of the merchant 120 such as a merchant name and merchant identifier. Additionally, the bank 140 may also receive information from third party sources 110 relating to one or more of the transaction or the merchant 120. For example, information that describes relationships between business entities, geolocation of business, as well as merchant customer data and/or merchant ownership. In an embodiment, the bank 140, the customer 130, the merchant 120, and the third party sources 110 may communicate over a network, which may be any suitable network such as a LAN, WAN, Intranet, or the Internet. Using this information, the machine learning algorithm 145 analyzes the transaction against previous transactions and knowledge of different merchants, and determines whether the transaction is a recurring charge associated with a bad actor.

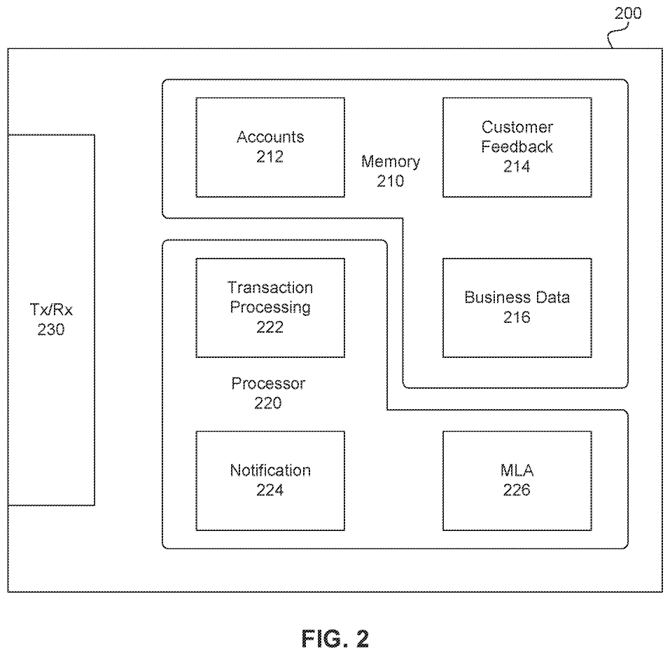

FIG. 2 illustrates a block diagram of an exemplary recurring charge detection system 200 according to various embodiments that could be implemented by bank 140. As shown in FIG. 2, the system 200 includes a transceiver 230 for sending and receiving communications with external entities. The system also includes a memory 210. In an embodiment, the memory 210 is constituted by one or more databases. The memory 210 stores various data to be used by the analysis algorithm.

As shown in FIG. 2, the memory 210 includes accounts 212, customer feedback 214, and business data 216. In an embodiment, the accounts 212 stores customer account data, including account numbers, transaction history, transaction amounts, etc. Customer feedback 214 stores customer complaints relating to different merchants and/or transactions, and other such feedback relevant to the suspicious recurring charge inquiry. In an embodiment, the customer feedback 214 is acquired from the customer using any suitable communication means, such as email, phone call, SMS text message, etc. Business data includes data relating to the merchants, such as ownership, location, and merchant reputation (e.g., previous complaints relating to the merchant 120 or an overall trustworthiness score based on previous complaints). In an embodiment, the business data 216 is acquired from any number of third parties via the transceiver 230.

The system 200 also includes processor 220. In accordance with various embodiments, the processor 220 may include any number of processors and/or servers capable of carrying out the processing and functionality described herein. The processor 220 includes transaction processing 222. The transaction processing 222 processes received transactions. Namely, the transaction processing 222 receives a pending charge from a merchant 120, extracts the relevant data from the transaction and carries out the processing of that transaction. In an embodiment, transaction processing 222 is also tasked with identifying potentially suspicious transactions, as will be discussed in further detail below. Transaction processing is also configured to terminate, halt, or otherwise take remedial action with respect to transactions identified to be suspicious recurring transactions.

Machine-learning algorithm 226 is trained according to previous transactions and their identifications of being either legitimate or suspicious. The Machine-learning algorithm is configured to receive as inputs the various data relating to the transaction, the merchant 120, and the customer 130, and analyze the transaction based on its knowledge of previous transactions. The machine-learning algorithm 226 outputs a determination of whether the transaction is legitimate (e.g., is unlikely to be a recurring charge and/or unlikely to be the result of fraud or deceit), or is suspicious (e.g., likely to be a recurring charge and/or the result of fraud or deceit).

Notification 224 receives an indication from the MLA 226 that a particular transaction has been identified as a suspicious recurring transaction. In an embodiment, notification 224 causes the transceiver 230 to transmit a notification message to the customer 130 informing them of the potentially suspicious transaction. In different embodiments, the notification message can inform the customer 130 that the transaction has been terminated, can inform the customer 130 that the transaction was flagged as suspicious and request confirmation from the customer 130, or notify the customer 130 that the transaction was flagged as suspicious and terminated.

In an embodiment of the operation, the system 200 receives customer feedback via the transceiver 230. The customer feedback identifies a particular transaction as being an unauthorized recurring transaction. The customer feedback is stored in customer feedback 214 within the memory 210 for later reference and training of the machine-learning algorithm 226.

Transaction processing 222 retrieves the transaction from one or more transaction databases 250. Transaction processing 222 then extracts relevant information from the transaction for use in identifying future unauthorized or suspicious transactions, such as transaction amount, transaction date, merchant identifier, merchant name, etc. Based on this information, the customer's account is retrieved from accounts 212 and additional data relating to the merchant 120 is retrieved from business data 216. In an embodiment, the business data 216 causes the transceiver to communicate with external entities in order to obtain the business data associated with the merchant 120.

The extracted information, the customer account information, and the business data are provided to the machine-learning algorithm, which then carries out operations in order to verify the customer's complaint. Specifically, the MLA 226, having been trained with previous transactions, determines whether the transaction is suspected of being a recurring transaction as well as whether the transaction is associated with an alleged bad actor.

In a first example, the MLA 226 analyzes a set of a customer's transactions included in their customer account data and detects multiple transactions that all originate from Company A. The transactions occur with perfect periodicity (e.g., once per month, week, year, etc.) and for the same amount each time. The MLA 226 identifies that all these factors weigh in favor of this being a recurring transaction. The MLA 226 then analyzes business data associated with Company A, which identify the company as reputable and a known business footprint. The MLA 226 then analyzes customer feedback from other previously-identified recurring transactions relating to Company A and finds generally positive feedback and few complaints. The MLA 226 determines each of these factors to weigh in favor of the recurring transaction being legitimate. The MLA 226 weighs and scores these factors, and generates an overall rating of the transaction that indicates that the transaction is likely a legitimate recurring charge.

In another example, the MLA 226 analyzes a set of a customer's transactions included in their customer account data and detects multiple transactions that occur with relative periodicity (e.g., once every 7-10 days, once every 28-32 days, etc.) and for substantially similar amounts (e.g., all within $1, all within $5, etc.). The MLA identifies that these factors weigh slightly in favor of this being a recurring charge, and also weigh in favor of it being fraudulent since typical (but not all) recurring charges are for a consistent amount of money. However, while some of the transactions originate from company B, others originate from companies C and D. The MLA 226 identifies that this factor weighs against this being a recurring charge and further in favor of any recurring charge being fraudulent. In other words, this factor suggests that this is not a recurring charge, but if it is determined to be a recurring charge based on all factors considered, then it is likely fraudulent since most recurring charges will originate from a single company identification.

In a first scenario of this example, the MLA 226 accesses the business data, and determines not only that companies B-D are collocated, but also that they have common addresses and/or are aliases of one another. The MLA 226 then access customer feedback and determines that each of companies B-D have generally negative feedback and have all received a disproportionate number of complaints (e.g., greater than a predetermined threshold of feedback is negative and/or complaint). The MLA 226 weighs both of these factors in favor of the transaction being a recurring charge, and in favor of it being fraudulent. The MLA 226 then weighs and scores these factors, and generates an overall rating of the transaction that indicates that the transaction is likely a fraudulent recurring charge.

In a second scenario of this same example, the MLA 226 access the business data, and determines that companies B-D are not collocated, are not known aliases of each other, and that each is known to deal in different goods/services from the others. The MLA 226 accesses customer feedback data and determines that while company D has generally negative feedback, companies B and C have generally positive feedback (e.g., greater than a predetermined threshold of feedback being positive), and company B is a large and well-known company with a good reputation. The MLA 226 weighs all these factors against the transactions being a recurring charge, and against fraudulence. The MLA 226 thus weighs and scores all these factors, and generates an overall rating of the transaction that indicates that the transaction is likely not a fraudulent recurring charge. In an embodiment, because at least one of the analyzed companies (i.e., company D) has substantially negative feedback, the MLA 226 further scrutinizes transactions relating to this company. Therefore, the MLA 226 conducts a further review of the customer's transaction data with respect to transactions originating from company D to attempt to discern a potential recurring charge that does not rely on transactions from one or more of companies B and C.

Depending on the result of the machine-learning algorithm analysis, notification 224 notifies the customer 130 of the result. For example, in an embodiment where the MLA 226 analysis is performed as a result of a customer complaint, the notification 224 informs the customer of the MLA 226 determination regardless of whether the MLA 226 identifies the transaction as being legitimate or suspicious. In another embodiment where the MLA 226 analysis is automatically instigated without customer input, then the notification 224 only causes the transceiver 230 to transmit a notification message to the customer 130 when the MLA 226 identifies a transaction as being both recurring and fraudulent.

If the MLA 226 determines that the transaction is legitimate, then transaction processing 222 completes processing of the transaction. However, if the MLA 226 determines that the transaction is suspicious and/or a result of deceit, then transaction processing terminates the transaction. In an embodiment, the transaction processing 222 only terminates the processing of the transaction once the MLA has flagged the transaction and the customer 130 and confirmed termination of the transaction.

The above explanation of the operation of the system 200 is merely one exemplary embodiment, and several modifications to the operation are available. For example, MLA 226 analysis can be triggered based on a complaint from a customer 130 or automatically. Automatic analysis can be performed in response to a cursory review of a transaction or for all transactions. The cursory review can be carried out, for example, by comparing a merchant identifier included in the transaction to known bad actors. In other embodiments, the amount of the transaction and/or the date of the transaction can be flagged based on a comparison to common recurring charge amounts/dates.

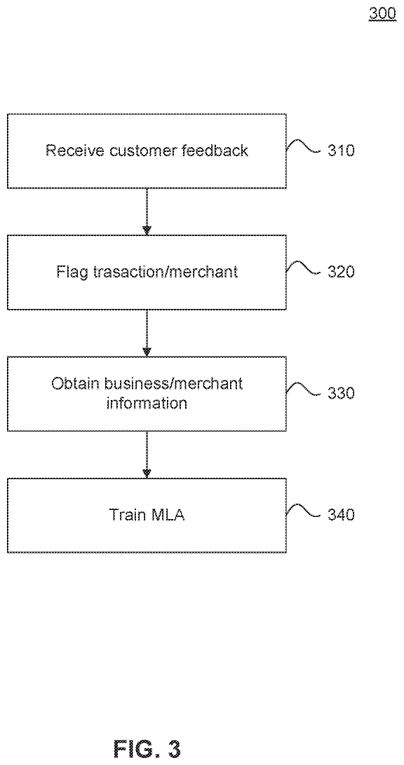

FIG. 3 illustrates a flowchart diagram of an exemplary method 300 for training an algorithm to detect suspicious recurring charges according to various embodiments. As shown in FIG. 3, the method begins by receiving customer feedback in step 310. In an embodiment, the customer feedback is a customer-initiated message disputing or requesting cancellation of a recurring charge. In response to the customer feedback, the transaction and/or the merchant associated with the transaction identified by the customer 130 is flagged in step 320. In an embodiment, the flag identifies one or more of the transaction or the merchant as being suspected fraudulent or bad actor.

Business and merchant information is obtained in step 330. In an embodiment, at least some of this information is extracted from the transaction data, such as merchant name, merchant ID, etc. In an embodiment, at least some of this information is obtained from external sources, such as business aliases, business ownership, business location, related business, etc. Once all the relevant information has been obtained, the machine-learning algorithm is trained with the transaction and related data in step 340. In other words, the machine-learning algorithm is provided the transaction data and the merchant data as an example of a flagged transaction. In this manner, the machine-learning algorithm will “learn” this information for future analysis of new transactions. In an embodiment, the customer feedback of numerous different customers and/or numerous different instances is analyzed.

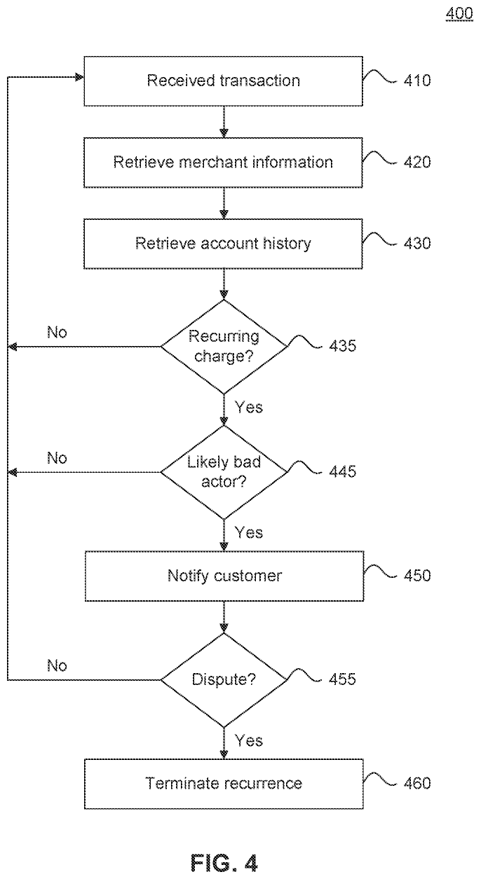

FIG. 4 illustrates a flowchart diagram of an exemplary method 400 for identifying suspicious recurring charges according to various embodiments. In the method 400, a transaction is received from a merchant in step 410. Merchant information is then retrieved in step 420 relating to the merchant associated with the transaction. Whereas some of the merchant information is extracted from the transaction data, such as merchant name and merchant ID, other information is obtained from external sources, such as business aliases, ownership, location, etc. Account history associated with the customer (who may the same or different as the customer(s) used to train the MLA in FIG. 3) is retrieved in step 430. In an embodiment, the account history includes prior transactions associated with the customer, previous recurring charge complaints and results of those complaints, etc.

The information retrieved in the previous steps is provided to the machine-learning algorithm, which has been trained with previous transactions and suspicious recurring charge decisions to analyze a particular transaction and the data associated therewith and make a determination as to whether the transaction is a suspicious recurring charge. Therefore, in step 435, the algorithm determines whether the charge is a recurring charge. In an embodiment, this determination is made based on a review of one or more of the transaction amount, transaction date, transaction history, merchant, transaction description, etc. If the MLA determines that the charge is not a recurring charge (435—No), then the method returns to step 410 to begin analysis of a new transaction.

If, however, the MLA identifies the transaction as likely being a recurring transaction (435—Yes), then the method proceeds to step 445. In step 445, the MLA identifies whether the recurring charge is likely a result of a bad actor, fraud, or deceit. In an embodiment, this determination is made based on a review of at least one of a comparison of the merchant name to known bad actors and aliases, a comparison of the transaction details to previously-flagged transactions associated with the current customer or other customers, etc. If the MLA determines that the transaction is not the result of a bad actor (445—No), then the method returns to step 410 to begin analysis of a new transaction.

If, however, the MLA determines that the transaction is the result of a bad actor, fraud, or deceit (445—Yes), then the customer is notified in step 450. In an embodiment, the notification to the customer includes an identification of the flagged transaction and requests that the customer confirm or contest the transaction. Based on a reply from the customer, a determination is made as to whether the customer disputes the transaction in step 455. If the customer confirms the transaction (455—No), then the flag is removed from the transaction, the transaction is permitted to be processed, and the method returns to step 410 for processing a future transaction.

If however, the customer disputes the transaction (455—Yes), then the transaction remains flagged, and the recurrence of the transaction is terminated in step 460. In an embodiment, termination of the recurrence means denying the transaction. At this stage, the transaction is also logged as a fraudulent recurring transaction and the merchant is logged as an untrustworthy merchant for future training and/or reference purposes. In this manner, recurring transactions are identified on behalf of the customer and brought to the customer's attention so that potentially fraudulent or deceptive transactions can be declined or terminated.

As discussed above, many variations of the above are available. For example, rather than analysis occurring for each transaction, only transactions that have been flagged from a cursory initial review or by a customer or unrelated customer are analyzed. In an embodiment, the recurrence determination (step 435) and the bad actor determination (445) are not separately determined, but rather are part of a combined analysis routine. Additionally, in embodiments, the notification to the customer does not request confirmation but rather merely notifies the customer of the transaction and the action taken with respect to the transaction.

Although the above has been described with respect to a single MLA, it should be understood that multiple different MLAs can be used. In an embodiment, one MLA is used for identifying a recurring transaction, and another is used for determining whether that transaction is fraudulent. In other embodiments, multiple MLAs may be used in combination for any/all of the necessary determinations.

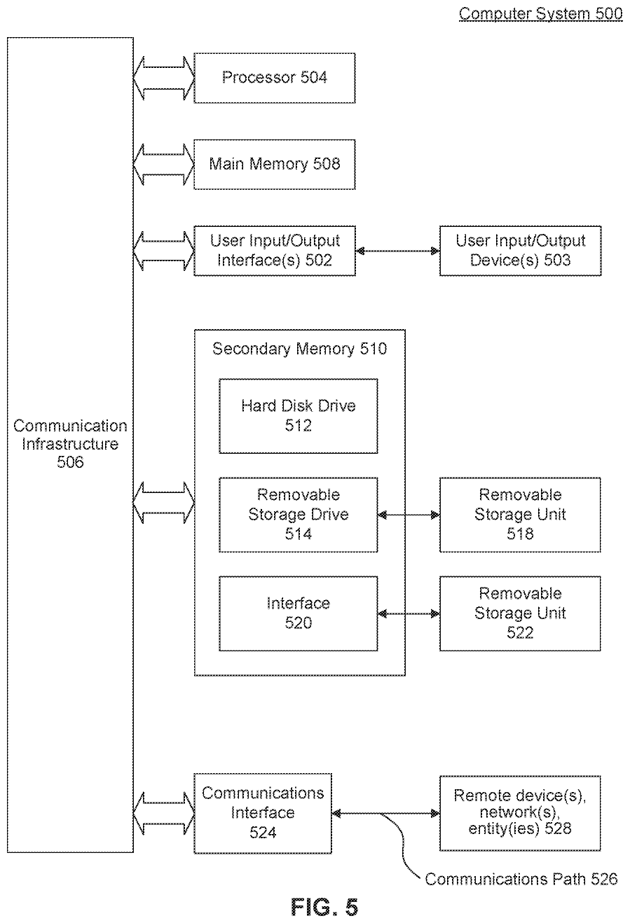

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving, by a management service of a cloud server, user feedback relating to a contested recurring operation;
identifying, by the management service of the cloud server, an operation instance and an entity associated with the operation instance;
obtaining, by the management service of the cloud server, information relating to the entity;
training, by the management service of the cloud server, a machine learning algorithm with the operation instance, entity, and information relating to the entity;
receiving, by the management service of the cloud server, a subsequent operation instance;
analyzing, by the management service of the cloud server, the subsequent operation instance using the machine learning algorithm;
determining, by the management service of the cloud server based on the analyzing, that the operation instance is at least one of a recurring operation or the result of fraud or deceit; and
performing, by the management service of the cloud server, a remedial action in response to the determining.

2. The method of claim 1, wherein the information relating to the entity is obtained from an external source.

3. The method of claim 1, wherein the analyzing includes extracting operation information and an entity identifier from the subsequent operation instance.

4. The method of claim 3, further comprising:
retrieving account information of a user, the account information associated with the subsequent operation instance; and
retrieving related operations that share at least one data point with the subsequent operation instance.

5. The method of claim 4, wherein the analyzing includes:
comparing operation data of the subsequent operation instance to the related operations; and
determining that the subsequent operation instance is the recurring operation based on the comparing.

6. The method of claim 5, further comprising:
determining that the recurring operation originates from a bad actor entity based on the comparing; and
in response to the determining:
transmitting, by the management service of the cloud server, a notification signal to the user associated with the recurring operation;
receiving, by the management service of the cloud server, a response message from the user disputing the recurring operation; and
terminating the recurring operation in response to the receiving of the response message.

7. The method of claim 6, further comprising:
performing additional training of the machine learning algorithm using the subsequent operation instance.

8. A system, comprising:
a memory that stores user account data and operation history;
a transceiver configured to communicate with external devices; and
one or more processors configured to:
receive user feedback relating to a contested recurring operation;
identify an operation instance and an entity associated with the recurring operation;
obtain information relating to the entity;
train a machine learning algorithm with the operation instance, entity, and information relating to the entity;
receive a subsequent operation instance;
analyze the subsequent operation instance using the machine learning algorithm;
determine, based on the analyzing, that the operation instance is at least one of a recurring operation or the result of fraud or deceit; and
performing a remedial action in response to the determining.

9. The system of claim 8, wherein the one or more processors are further configured to cause the transceiver to communicate with at least one external source to obtain the information relating to the entity.

10. The system of claim 9,
wherein the one or more processors are further configured to extract operation information and an entity identifier from the subsequent operation instance.

11. The system of claim 10, wherein the one or more processors are further configured to:
retrieve account information of a user, the account information associated with the subsequent operation instance; and
retrieve related operations that share at least one data point with the subsequent operation instance.

12. The system of claim 11, wherein the analyzing further includes:
comparing the operation data of the subsequent operation instance to the related operations; and
determine that the subsequent operation instance is the recurring operation based on the comparing.

13. The system of claim 12, wherein the one or more processors are further configured to determine that the recurring operation originates from a bad actor entity based on the comparing; and
in response to the determining:
cause the transceiver to transmit a notification signal to the user associated with the recurring operation;
receive, via the transceiver, a response message from the user that disputes the recurring operation; and
canceling the recurring operation in response to the receiving of the response message.

14. The system of claim 13, wherein the one or more processors are further configured to:
perform additional training of the machine learning algorithm using the subsequent operation instance.

15. A method, comprising:
receiving, by a management service of a cloud server, an operation instance between a user and an entity;
retrieving, by the management service of a cloud server, related operations that share at least one characteristic with the operation instance;
retrieving, by the management service of a cloud server, account information associated with the user;
retrieving, by the management service of a cloud server, entity information associated with the entity;
analyzing, by the management service of a cloud server, the related operations, the account information, and the entity information; and
flagging, by the management service of a cloud server, the operation instance as being both a recurring operation and a result of a bad actor entity, fraud, or deceit based on the analyzing.

16. The method of claim 15, further comprising transmitting a notification message to the user, the notification message informing the user of the flagged operation instance,
wherein the notification message includes a request for confirmation or rejection of the flagged operation instance.

17. The method of claim 16, further comprising:
receiving, by the management service of a cloud server, a response message from the user that confirms the flagged operation instance as being a legitimate recurring operation;
processing, by the management service of a cloud server, the flagged operation instance; and
updating, by the management service of a cloud server, a model that performs the analyzing based on the response message.

18. The method of claim 16, further comprising:
receiving, by the management service of a cloud server, a response message from the user that rejects the flagged operation instance; and
terminating, by the management service of a cloud server, the flagged operation instance in response to the receiving of the response message.

19. The method of claim 18, wherein the flagging of the operation instance includes:
first identifying the operation instance as a recurring operation; and
second identifying the recurring operation as being at least one of associated with a bad actor entity, the result of fraud on the part of the entity, or the result of deceit on the part of the entity.

20. The method of claim 19, wherein the first identifying is based on an analysis of the related operations and the account information, and
wherein the second identifying is based on the related operations and the entity information.
